(19) United States
(12) Patent Application Publication
(10) Pub. No.: US 2010/0073486 A1
(43) Pub. Date: Mar. 25, 2010

(54) MULTI-DIMENSIONAL INPUT APPARATUS

(76) Inventor: Huei Chuan TAI, Science-Based Industrial Park (TW)

Correspondence Address: Muncy, Geissler, Olds & Lowe, PLLC, P.O. BOX 1364, FAIRFAX, VA, 22038-1364, US

(21) Appl. No.: 12/261,720

(22) Filed: Oct. 30, 2008

(30) Foreign Application Priority Data
Sep. 24, 2008 (TW) 097136689

(51) Int. Cl. H04N 5/225; G06F 3/045; G06F 3/033

(52) U.S. Cl. 348/207.1; 345/174; 345/184; 348/207.2; 348/E05.024

(57) ABSTRACT

A multi-dimensional input apparatus sends out an instruction to operate an image capture process or an application program after receiving a single touch, slide or circling, or receiving several touches, slides or circlings. The multi-dimensional input apparatus communicates with the control interface of an image capture program or an application program in a wired or wireless way and provides an alternative instrument for operating the image capture process or the application program.

### BACKGROUND OF THE INVENTION

1. Field of the Invention

The present invention relates to an integrated input apparatus, particularly to a multi-dimensional integrated input apparatus.

2. Description of the Related Art

Whether an electronic device is equipped with an advanced input apparatus is an important factor determining whether a consumer purchases the electronic device. For example, in addition to a keyboard, a desktop computer is usually equipped with a mouse as the input apparatus. For a laptop computer, the keyboard, mouse, and touchpad are usually the fundamental input apparatuses. However, it is uneasy for a user to collect or carry about the abovementioned input apparatuses. Therefore, it is a trend to fabricate simpler and more friendly input device for the customer.

### SUMMARY OF THE INVENTION

The present invention is directed to an integrated input apparatus for a user to instinctively operate an image capture device and shifts among different menus.

The present invention is directed to a multi-dimensional integrated input apparatus for a user to input instructions with a plurality of input elements.

To achieve the abovementioned objectives, one embodiment of the present invention comprises a touchscreen, a button, a pressure sensor, and a knob. The button is arranged in the center of the touchscreen. The pressure sensor is arranged on the side wall of the apparatus and surrounds the touchscreen. The knob is also arranged on the side wall of the apparatus and surrounds the touchscreen. The knob can rotate around the touchscreen and move linearly in the pressure sensor.

Below, the embodiments are described in detail in cooperation with the attached drawings to make easily understood the objectives, technical contents, characteristics and accomplishments of the present invention.

### BRIEF DESCRIPTION OF THE DRAWINGS

FIG. 1 is a schematic diagram showing a multi-dimensional integrated input apparatus according to the present invention;

FIG. 2 is a schematic diagram showing the connection of a multi-dimensional integrated input apparatus and a hardware according to the present invention;

FIG. 3A is a schematic diagram showing the control interface presented on a display according to one embodiment of the present invention;

FIG. 3B is a schematic diagram showing a display element of a multi-dimensional input apparatus according to one embodiment of the present invention;

FIG. 3C is a schematic diagram showing a menu of a control interface presented on a display according to one embodiment of the present invention:

FIG. 4A is a schematic diagram showing a control interface cooperating with a multi-dimensional integrated input apparatus according to one embodiment of the present invention;

FIG. 4B is a schematic diagram showing an interface of an audio/video play program cooperating with a multi-dimensional integrated input apparatus according to one embodiment of the present invention;

FIG. 4C is a schematic diagram showing an interface of a webpage browser program cooperating with a multi-dimensional integrated input apparatus according to one embodiment of the present invention; and

FIGS. 5A-5D are schematic diagrams showing operation modes of a touchscreen of a multi-dimensional integrated input apparatus according to one embodiment of the present invention.

### DETAILED DESCRIPTION OF THE INVENTION

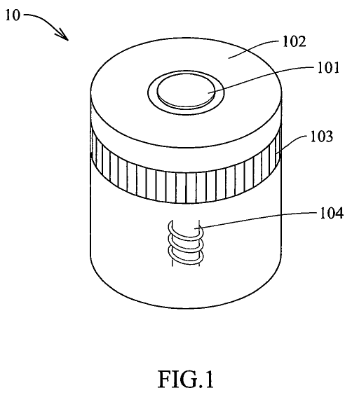

Refer to FIG. 1 a schematic diagram showing a multi-dimensional integrated input apparatus according to the present invention. The exemplary multi-dimensional input apparatus 10 in a cylinder shape comprises a button 101, a touchscreen 102, a knob 103 and a pressure sensor 104. When cooperating with application software, the input elements of the multi-dimensional input apparatus 10 respectively control different control items or jointly control an identical control item. The input elements can respectively detect/accept different actions or jointly detect/accept an identical action. The button 101 is arranged in the center of a base surface of the cylinder, and the touchscreen 102 surrounds the button 101. The knob 103 and the pressure sensor 104 are arranged on the side wall of the cylinder and surrounded by the touchscreen 102. The touchscreen 102 may execute both detection and display.

Below are described the actions the input elements perform or receive. However, it is only to exemplify the present invention but not to limit the scope of the present invention.

In one embodiment of the present invention, the button 101 may be automatically rebounded to its original position after released from the applied force. The actions applied to the button 101 include a rapid single-clicking, a rapid double-clicking, and a longer-time pressing. The touchscreen 102 is not moved by any action. The actions applied on the touchscreen 102 include a single-clicking on a single contact point, a double-clicking on a single contact point, a single or several continuous slides of a single finger (the slide path is inside the touchscreen 102), a single or several discrete slides of a single finger (the slide path crosses the button 101), and a single or several continuous slides of double fingers. The touchscreen 102 may be divided into several regions respectively receiving different actions at the same time. The knob 103 with scales may be freely rotated without rebound after released from the applied force. The knob 103 may rotate clockwise and counterclockwise. In cooperation with software, firmware or hardware, the travel amount in response to the rotated knob 103 may be tuned by cooperating the knob 103 with the displacement of the pressure sensor 104. For example, when the knob 103 is operated alone, the rotation of the knob 103 generates a travel amount in a fine-tuning mode. When the knob 103 is operated in cooperation with the pressure senor 104, the rotation of the knob 103 generates the travel amount in a coarse-adjustment mode. The travel amount generated in the coarse-adjustment mode is greater than that in the fine-tuning mode. In the coarse-adjustment mode, the relationship between the downward displacement of the pressure sensor 104 and the magnification ratio of the travel amount and the rotation of the knob 103 may be linear or nonlinear.

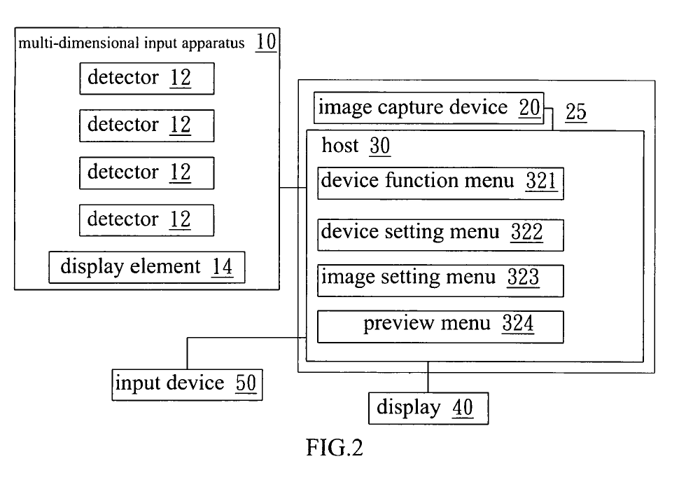

FIG. 2 is a schematical diagram illustrating the connection of the multi-dimensional integrated input apparatus and a hardware according to the present invention. In FIG. 2, a host 30 is electrically coupled to an image capture device 20, an input device 50, a display 40, and a multi-dimensional input apparatus 10. In one embodiment, the host 30 is an electronic device with a processor, such as a desktop computer, or a laptop computer, and the electronic device is electrically coupled to the image capture device 20, the input device 50, the display 40, and the multi-dimensional input apparatus 10 in a wired or wireless way. The image capture device 20 is an image scanner or a device having a scanning function, such as a multi-function printer or a facsimile machine. Alternatively, the image capture device 20 has a built-in processor to integrate with the host 30 to form an image capture system 25. The display 40 is LCD (liquid crystal display), PDP (Plasma Display Panel), or a device having a display function. The input device 50 is a wired or wireless keyboard. However, the present invention is not limited by the abovementioned embodiment.

In one embodiment, the host 30 is configured for processing the image capture device 20, the display 40 and the multi-dimensional input apparatus 10. In the case of a desktop computer that has an operating system to control the input device 50 and the display 40, the host 30 further has a control interface interacting with the image capture device 20, and the multi-dimensional input apparatus 10, etc. The control interface may be implemented by suitable application software and presented on the display 40. The control interface provides a device function menu 321, a device setting menu 322, an image setting menu 323, and a preview menu 324 to interact with the image capture device 20 and the multi-dimensional input apparatus 10.

The exemplary multi-dimensional input apparatus 10 is electrically coupled to the host 30 in a wired or wireless way. The multi-dimensional input apparatus 10 further comprises several detectors 12 and a display element 14. The display element 14 and one detector 12 are corresponding to the touchscreen 102 in FIG. 1. The other detectors 12 are respectively corresponding to the other input elements. The display-related detector 12 detects the touches that a limb of a creature or an appropriate tool directly or indirectly makes on the multi-dimensional input apparatus 10. The display element 14 has at least one section corresponding to all or a portion of the menus of the control interface of the host 30, whereby the user may learn the current menus provided by the multi-dimensional input apparatus 10. The icons in the menus displayed by the display element 14 include characters, numerals, symbols, patterns, or a combination thereof. The display element 14 may present icons in a static mode or a flashing mode. However, the present invention is not limited to the abovementioned icons or modes. In the present invention, the display-related detector 12 may be a capacitive-type, IR-type, resistive-type, or ultrasonic-type detector, but the present invention is not limited to the abovementioned types of detectors. The exemplary display element 14 may be LCD, PDP a LED display, or an OLED (Organic Light Emitting Diode) display, but the present invention is not limited to the abovementioned types of displays. The multi-dimensional input apparatus 10 has a communication element (not showing in the drawings) to transmit the control instructions corresponding to touches in a wired or wireless way. When electrically coupled to the host 30 in a wireless way, the multi-dimensional input apparatus 10 has a power supply (not showing in the drawings), powering the detectors 12 and the display element 14. When electrically coupled to the host 30 or the image capture device 20 in a wired way, such as via USB, the multi-dimensional input apparatus 10 can acquire power from USB pins. Alternatively, the multi-dimensional input apparatus 10 may be directly integrated with the image capture device 20.

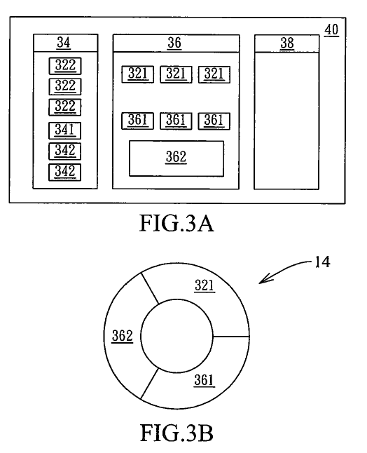

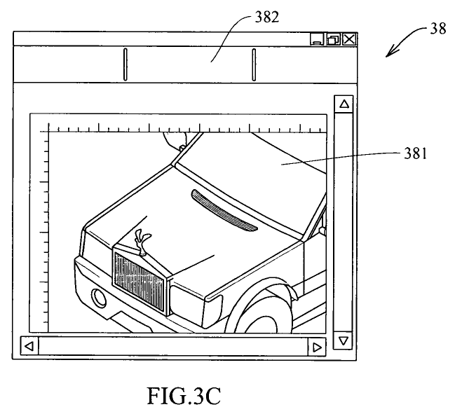

FIG. 3A is a schematic diagram showing the control interface presented on the display according to one embodiment of the present invention. FIG. 3B is a schematic diagram schematically showing the display element of the multi-dimensional input apparatus according to one embodiment of the present invention. In FIG. 3A, the host is normally electrically coupled to the image capture device, the input device, the display 40 and the multi-dimensional input apparatus and executes the functions of the control interface. The user may use a keyboard or mouse to select the items he intends to execute. In one embodiment, the control interface presents the image capture device related menus on the current frame of the display 40, including a function menu 36, a setting menu 34 and a preview menu 38, which are independent without an execution priority. The block of the function menu 36 contains the capturing-relevant function of items corresponding to the hardware operations of the image capture device, such as prescan and overview. The function menu 36 may contain execution buttons 361 and a submenu 362. Refer to FIG. 3B, when the function menu 36 is enabled, the execution buttons 321 and 361 and the submenu 362 are correspondingly presented on the display element 14 of the multi-dimensional input apparatus and respectively corresponding to different input elements of the multi-dimensional input apparatus. The block of the setting menu 34 contains items for setting the parameters of scanned objects, including the sources and sizes of the scanned objects. The setting menu 34 may contain execution buttons 322, a numeral selection box 341, and input boxes 342. When the setting menu 34 is enabled, the execution buttons 322, numeral selection box 341 and input boxes 342 are correspondingly presented on the display element 14 of the multi-dimensional input apparatus and respectively corresponding to different input elements of the multi-dimensional input apparatus. Refer to FIG. 3C. The block of the preview menu 38 contains the image 381 of a scanned object and preview selection items 382. When the preview menu 38 is enabled, the preview selection items 382 are correspondingly presented on the display element 14 of the multi-dimensional input apparatus and respectively linked to different input elements of the multi-dimensional input apparatus.

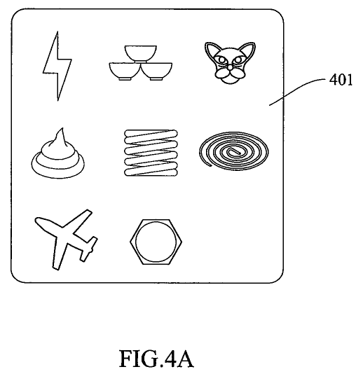

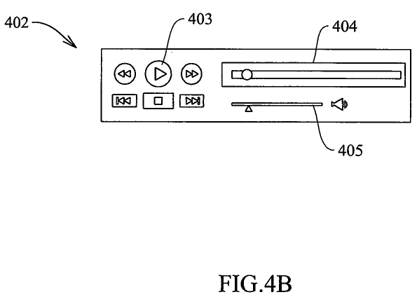

Herein, it should be noted: the items correspondingly presented on the multi-dimensional input apparatus is not limited to buttons but may also be other items, such as numerals. Different actions are detected by the multi-dimensional input apparatus and related to different items of the control interface. The multi-dimensional input apparatus of the present invention also applies to controlling non-image capture devices. Refer to FIG. 4A. Suppose that some application programs are installed in a system, such as a computer, and that the control interface provides a menu of the application programs for the user. When the exemplary multi-dimensional input apparatus is coupled to to the control interface, the user can use the multi-dimensional input apparatus to select and execute a program. For example, the user presses the button to demand that the control interface execute the instruction of popping out a menu 401; then the user uses the touchscreen and the knob to select and execute desired programs.

Below, several embodiments are used to exemplify the applications of the multi-dimensional input apparatus of the present invention to different application programs. FIG. 4B is a schematic diagram the interface of an audio/video play program. When the multi-dimensional input apparatus of the present invention cooperates with an audio/video play program interface 402, the user can use the button to input an instruction to execute a play/pause function 403 and use the touchscreen to input an instruction to execute a position slider function 404. The user can also rotate two fingers on the touchscreen to input an instruction to execute a fast forward/backward function. The user can use the knob to input an instruction to execute a volume slider function 405. FIG. 4C is a schematic diagram showing an interface of a webpage browser program. When the multi-dimensional input apparatus of the present invention cooperates with a webpage browser program interface 412, the user can input an instruction with the touchscreen to operate a vertical scrollbar 414 and input an instruction with the knob to operate a horizontal scrollbar function 416. The user can also rotate two fingers on the touchscreen to input an instruction to execute a zoom-in/zoom-out function.

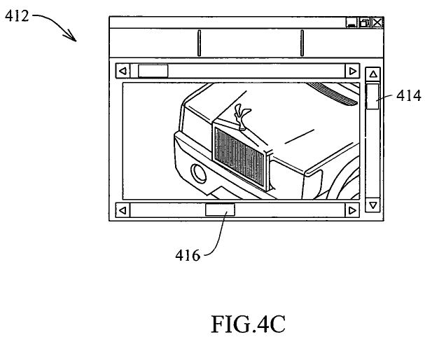

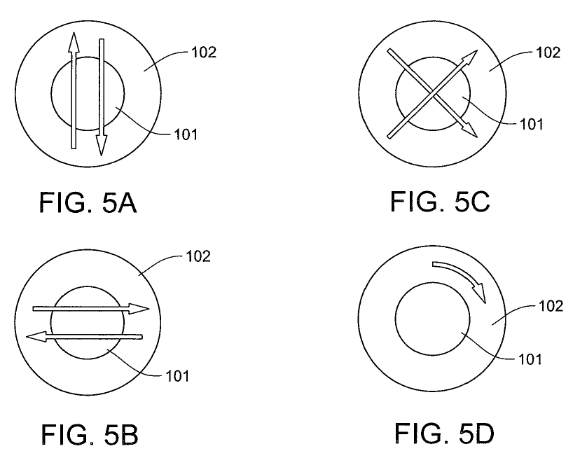

Refer to FIGS. 5A-5D for the augmented description of FIG. 4C. As shown in FIG. 5A, the user applies a vertical movement (indicated by the arrows) on the touchscreen 102; although the movement crosses the button 101, the touchscreen can still recognize the vertical movement and sends out an instruction to operate the vertical scrollbar 414 of the webpage browser program interface 412. As shown in FIG. 5B, the user applies a horizontal movement on the touchscreen 102 to operate the horizontal scrollbar 416 of the webpage browser program interface 412. As shown in FIG. 5C, the user applies a diagonal movement on the touchscreen 102 to simultaneously operate the vertical scrollbar 414 and the horizontal scrollbar 416 of the webpage browser program interface 412.

FIG. 5D schematically shows another operation mode of the touchscreen 102, wherein the touchscreen 102 is divided into four quadrant zones of an orthogonal coordinate system. In one embodiment, when the user slides his finger from Quadrant 2 to Quadrant 1, the system presumes that the user intends to operate the horizontal scrollbar 416 of the webpage browser program interface 412. If the user does not lift his finger from the touchscreen 102 but slides his finger on the touchscreen 102 clockwise, the system moves the horizontal scrollbar 416 in the original direction. If the user does not lift his finger from the touchscreen 102 but slides his finger on the touchscreen 102 counterclockwise, the system moves the horizontal scrollbar 416 in a direction opposite to the original direction. The enable state of the horizontal scroll function will not stop until the user lifts his finger from the touchscreen 102. When the user slides his finger from Quadrant 1 to Quadrant 2, Quadrant 3 to Quadrant 4, or Quadrant 4 to Quadrant 3, the cases are similar.

When the user slides his finger from Quadrant 1 to Quadrant 4, the system presumes that the user intends to operate the vertical scroll bar 414 of the webpage browser program interface 412. If the user does not lift his finger from the touchscreen 102 but slides his finger on the touchscreen 102 clockwise, the system moves the vertical scrollbar 414 in the original direction. If the user does not lift his finger from the touchscreen 102 but slides his finger on the touchscreen 102 counterclockwise, the system moves the vertical scroll bar 414 in a direction opposite to the original direction. The enable state of the vertical scroll function will not stop until the user lifts his finger from the touchscreen 102. When the user slides his finger from Quadrant 4 to Quadrant 1, Quadrant 2 to Quadrant 3, or Quadrant 3 to Quadrant 2, the cases are similar.

The embodiments described above are to demonstrate the technical contents and characteristics of the present invention to enable the persons skilled in the art to understand, make, and use the present invention. However, it is not intended to limit the scope of the present invention. Any equivalent modification or variation according to the spirit of the present invention is to be also included within the scope of the present invention.

What is claimed is:

1. A multi-dimensional input apparatus comprising:
a touchscreen;
a button element arranged in a center of said touchscreen;
a pressure sensor arranged on a side wall of said touchscreen and surrounding said touchscreen; and
a knob element arranged on said side wall of said touchscreen, surrounding said touchscreen, wherein said knob is operated by rotating around said touchscreen and moving linearly along said pressure sensor.

2. The multi-dimensional input apparatus according to claim 1, wherein said multi-dimensional input apparatus is in a shape of a cylinder, said touchscreen is arranged on a base surface of said cylinder and has an annular shape; said button element is arranged in a center of said annular shape, and said pressure sensor and said knob element are arranged on a side wall of said cylinder.

3. The multi-dimensional input apparatus according to claim 1, wherein said touchscreen further comprises one of a capacitive-type detector, an IR-type detector, a resistive-type detector and an ultrasonic-type detector, and a related circuit.

4. The multi-dimensional input apparatus according to claim 1 further comprising a communication element communicating with an external system in a wired way.

5. The multi-dimensional input apparatus according to claim 1 further comprising a communication element communicating with an external system in a wireless way.

6. The multi-dimensional input apparatus according to claim 5 further comprising a power supply powering said touchscreen, said button element, said pressure sensor, said knob element and said communication element.

7. The multi-dimensional input apparatus according to claim 1, wherein operational actions applied on said touchscreen include a single touch on a single contact point, several successive touches on a single contact point, a single slide, several simultaneous slides, a single circling, and several simultaneous circlings and moving.

8. An image capture system, comprising an image capture device, a host, and a multi-dimensional input apparatus, which are electrically connected to each other, and characterized in:
that said host provides a control interface to communicate with and control said image capture device and said multi-dimensional input apparatus, wherein said control interface provides a plurality of selection items for said image capture device, and
that said multi-dimensional input apparatus comprises
a plurality of detectors respectively detecting actions applied thereto; and
a display element connected with one said detector and presenting icons respectively corresponding to a portion of said selection items, wherein when one action is applied to one said icon, said detector connected with said display element sends an instruction to said control interface to execute one said selection item.

9. The image capture system according to claim 8, wherein said display element is a liquid crystal display, a plasma display panel, a light emitting diode display, or an organic light emitting diode display.

10. The image capture system according to claim 8, wherein each of said detectors further comprises one of a capacitive-type detector, an IR-type detector, a resistive-type detector and an ultrasonic-type detector, and a related circuit.

11. The image capture system according to claim 8, wherein said host is a processor arranged inside said image capture device.

12. The image capture system according to claim 8, wherein said host is a desktop computer or a laptop computer.

13. The image capture system according to claim 8, wherein said multi-dimensional input apparatus further comprises a communication element communicating with said host in a wired way.

14. The image capture system according to claim 8, wherein said multi-dimensional input apparatus further comprises a communication element communicating with said host in a wireless way.

15. The image capture system according to claim 8, wherein said image capture device is an image scanner or a multi-function printer.
